(19) United States
(12) Patent Application Publication
(10) Pub. No.: US 2009/0244080 A1
(43) Pub. Date: Oct. 1, 2009

(54) LINE BUFFER CIRCUIT, IMAGE PROCESSING APPARATUS, AND IMAGE FORMING APPARATUS

(76) Inventor: Tomoya ISHIKURA, Nara-shi (JP)

Correspondence Address: BIRCH STEWART KOLASCH & BIRCH, PO BOX 747, FALLS CHURCH, VA, 22040-0747, US

(21) Appl. No.: 12/409,158

(22) Filed: Mar. 23, 2009

(30) Foreign Application Priority Data
Mar. 28, 2008 (JP) 2008-088029

(51) Int. Cl. G09G 5/36

(52) U.S. Cl. 345/560

(57) ABSTRACT

When writing data into a single port memory, a plurality of data corresponding to predetermined number of pixels that are packed by a data packing section is written together into the single port memory. When reading data from the single port memory, data corresponding to predetermined number of pixels are read out together from the single port memory. After writing the data corresponding to predetermined number of pixels into the single port memory and before next data corresponding to predetermined number of pixels that are to be written into the single port memory are inputted to the line buffer circuit, data are read from the single port memory. This allows providing a line buffer circuit capable reading and writing data at high speed, without requiring a larger circuit configuration.

This Nonprovisional application claims priority under 35 U.S.C. §119(a) on Patent Application No. 2008-088029 filed in Japan on Mar. 28, 2008, the entire contents of which are hereby incorporated by reference.

### TECHNICAL FIELD

The present invention relates to a line buffer circuit including a single port memory in which image data corresponding to one line is stored, and to an image processing apparatus and an image forming apparatus each including the line buffer circuit.

### BACKGROUND ART

Conventionally, a FIFO (First-in-First-out) memory has been used as a line buffer included in an image processing apparatus for example.

A technique for speeding operation of a FIFO memory is disclosed in Patent Literature 1 for example, in which a FIFO memory is a dual port memory including two memory circuits, and writing and reading of data are alternately performed with respect to each of the two memory circuits.

### Citation List

Patent Literature 1

Japanese Patent Application Publication, Tokukaihei, No. 10-3782 A (Publication Date: Jan. 6, 1998)

Patent Literature 2

Japanese Patent Application Publication, Tokukai, No. 2002-232708 A (Publication Date: Aug. 16, 2002)

### SUMMARY OF INVENTION

Technical Problem

However, in the technique of Patent Literature 1, one FIFO memory includes two memory circuits, and therefore it is necessary to mount a memory control circuit for controlling four ports in total of the two memory circuits, resulting in a larger circuit size. Further, providing the FIFO memory with two memory circuits increases the number of terminals of the memory circuits twice as large as the number of terminals when providing only one memory circuit. This increases the number of wires and consequently increases the area where the FIFO memory is provided.

Solution to Problem

The present invention was made in view of the foregoing problem, and an object of the present invention is to provide a line buffer circuit capable of reading and writing data at a high speed, without requiring a larger circuit configuration.

In order to solve the foregoing problem, the line buffer circuit of the present invention is a line buffer circuit, including: a single port memory in which image data corresponding to 1 line is stored; and a memory control section for controlling writing and reading of data to and from the single port memory, the line buffer circuit including: a data packing section for packing a plurality of data corresponding to predetermined number of pixels, respectively, the data being to be written into the single port memory; a data unpacking section for unpacking data corresponding to predetermined number of pixels, respectively, that is read out from the single port memory, into a plurality of data each corresponding to a pixel; and a data output section for sequentially outputting the plurality of data each corresponding to a pixel in such a manner that each data is outputted with respect to each pixel, the plurality of data being obtained as a result of unpacking by the data unpacking section, when writing data into the single port memory, the memory control section writing together, into the single port memory, the plurality of data corresponding to predetermined number of pixels that are packed by the data packing section, when reading data from the single port memory, the memory control section reading together, from the single port memory, the data corresponding to predetermined number of pixels, after writing the data corresponding to predetermined number of pixels into the single port memory and before next data corresponding to predetermined number of pixels that are to be written into the single port memory are inputted to the line buffer circuit, the memory control section reading data from the single port memory, and in a case where data corresponding to a pixel at an end of a line is inputted to the line buffer circuit, even when the number of pixels whose data has been inputted to the line buffer circuit, but has not yet been written into the single port memory does not reach the predetermined number of pixels, the memory control section causing the data packing section to pack the unwritten data of the pixels and causing the packed data to be written together into the single port memory.

Advantageous Effects of Invention

With the arrangement, when writing data into the single port memory, the memory control section writes together, into the single port memory, the plurality of data corresponding to predetermined number of pixels that are packed by the data packing section, and when reading data from the single port memory, the memory control section reads together, from the single port memory, the data corresponding to predetermined number of pixels. After writing the data corresponding to predetermined number of pixels into the single port memory and before next data corresponding to predetermined number of pixels that are to be written into the single port memory are inputted to the line buffer circuit, the memory control section reads data from the single port memory.

Consequently, the present invention allows performing the writing process and the reading process with a process time similar to the time required by a line buffer circuit including a dual port memory that is described in Patent Literature 1 for example. Further, unlike the technique of Patent Literature 1, the present invention does not include a dual port memory, and therefore the present invention may have a smaller circuit configuration than the technique of Patent Literature 1. That is, the present invention may have a smaller circuit configuration than a line buffer circuit including a dual port memory, and the present invention allows reading and writing of data with a process speed similar to that of the line buffer circuit including a dual port memory. Further, the present invention allows reducing the number of access to a memory, compared with a conventional line buffer circuit including a single port memory or a dual port memory. This allows reducing power consumption.

For a fuller understanding of the nature and advantages of the invention, reference should be made to the ensuing detailed description taken in conjunction with the accompanying drawings.

### BRIEF DESCRIPTION OF DRAWINGS

FIG. 1

FIG. 1 is a block diagram illustrating a configuration of a line buffer circuit in accordance with an embodiment of the present invention.

FIG. 2

FIG. 2 is a block diagram illustrating an image processing apparatus in accordance with an embodiment of the present invention.

FIG. 3

FIG. 3 is a block diagram illustrating a signal processing circuit including the line buffer circuit in FIG. 1.

FIG. 4

FIG. 4 is an explanatory drawing illustrating an example of a filter coefficient used in a spatial filter process section in the image processing apparatus in FIG. 2.

FIG. 5

FIG. 5 is an explanatory drawing illustrating a relation between a target pixel and a reference pixel in a dilation process and an erosion process that are performed by the image processing apparatus in FIG. 2.

FIG. 6

FIG. 6 is an explanatory drawing illustrating a relation between a target pixel and a reference pixel in a dilation process and an erosion process that are performed by the image processing apparatus in FIG. 2.

FIG. 7

FIG. 7 is a signal waveform chart illustrating enable signals used in the image processing apparatus in FIG. 2.

FIG. 8

FIG. 8 is a block diagram illustrating a modification example of the signal processing circuit in FIG. 1.

FIG. 9

FIG. 9 is a signal waveform chart illustrating signals processed in the line buffer circuit in FIG. 1.

FIG. 10

FIG. 10 is a signal waveform chart illustrating signals processed in the line buffer circuit in FIG. 1.

FIG. 11

FIG. 11 is a signal waveform chart illustrating signals processed in the line buffer circuit in FIG. 1.

FIG. 12

FIG. 12 is a block diagram schematically illustrating a configuration of an image processing apparatus in accordance with another embodiment of the present invention.

### DESCRIPTION OF EMBODIMENTS

One embodiment of the present invention is described below.

(1. Entire Structure)

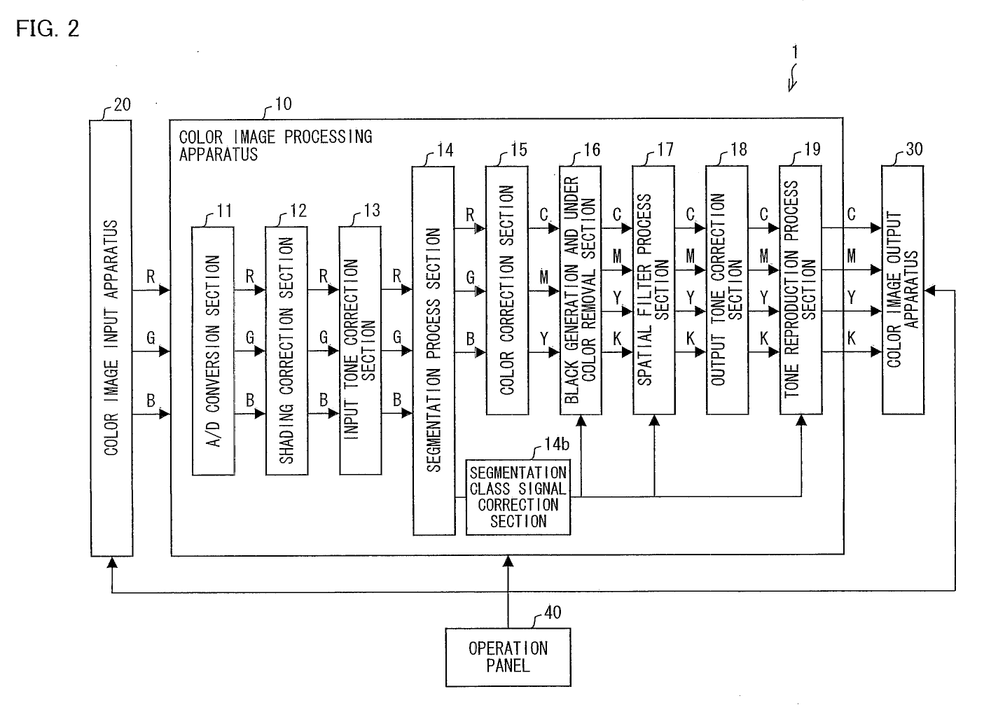

FIG. 2 is a block diagram schematically illustrating a structure of a digital color multifunction printer (image processing apparatus, image forming apparatus) 1 including a color image processing apparatus 10 in accordance with the present embodiment.

The color image input apparatus 20 includes a scanner section including a Charge Coupled Device (hereinafter referred to as CCD) for example. The color image input apparatus 20 causes the CCD to read, as RGB analog signals, an optical image reflected from paper on which a document image is recorded, and outputs the signals to the color image processing apparatus 10.

As illustrated in FIG. 2, the color image processing apparatus (image processing apparatus) 10 includes an A/D conversion section 11, a shading correction section 12, an input tone correction section 13, a segmentation process section 14, a color correction section 15, a black generation and under color removal section 16, a spatial filter process section 17, an output tone correction section 18, and a tone reproduction process section 19. A color image input apparatus 20 and a color image output apparatus 30 are connected to the color image processing apparatus 10. The color image processing apparatus 10, the color image input apparatus 20, and the color image output apparatus 30 constitute the digital color multifunction printer 1. The multifunction printer 1 is provided with an operation panel 40.

The analog signals read by the color image input apparatus 20 are transmitted in the color image processing apparatus 10 through the A/D conversion section 11, the shading correction section 12, the input tone correction section 13, the segmentation process section 14, the color correction section 15, the black generation and under color removal section 16, the spatial filter process section 17, the output tone correction section 18, and the tone reproduction process section 19 in this order, and are output to the color image output apparatus 30 as CMYK digital color signals.

The A/D conversion section 11 converts the inputted RGB analog signals into RGB digital signals. The shading correction section 12 removes various distortions produced in an illumination system, an image focusing system, and an image sensing system of the color image input apparatus 20 from the RGB digital signals transmitted from the A/D conversion section 11.

The input tone correction section 13 adjusts color balance of the RGB signals (RGB reflectance signals) from which the various distortions have been removed by the shading correction section 12, and converts the RGB signals into signals such as density signals that are easily processed in the color image processing apparatus 10. Further, the input tone correction section 13 carries out an image quality adjustment process such as contrast and removes background density.

The segmentation process section 14 separates each pixel of an input image represented by the RGB signals into either one of a text region, a halftone dot region, or a photograph (continuous tone) region. On the basis of a result of the separation, the segmentation process section 14 outputs a segmentation class signal, indicating which region a pixel of the input image belongs to, to a segmentation class signal correction section 14b, and outputs the input signals as received from the input tone correction section 13 to the subsequent color correction section 15 without any modification.

A method for carrying out the segmentation process is not particularly limited, and may be any of conventional and publicly known methods. The present embodiment employs the segmentation process method disclosed in Patent Literature 2 so that input image data is separated into a text region, a halftone dot region, a photograph region, and a page background region.

In the method disclosed in Patent Literature 2, there are calculated (i) a maximum density difference that is a difference between the minimum density value and the maximum density value in a block having n×m (e.g. 15×15) pixels including a target pixel, and (ii) a total density busyness that is a total of an absolute value of a difference in density between adjacent pixels. The maximum density difference is compared with a predetermined maximum density difference threshold value, and the total density busyness is compared with a total density busyness threshold value. According to the results of the comparisons, a target pixel is separated into a text region, a halftone dot region, and other region (page background region, photograph region).

Specifically, in the case of the page background region, density distribution has little density change and therefore the maximum density difference and the total density busyness are very little. In the case of the photograph region (here, a continuous tone region such as a silver-halide photograph is referred to as a photograph region), density distribution shows smooth density change, and therefore the maximum density difference and the total density busyness are small and a little larger than those of the page background region. That is, in the cases of the page background region and the photograph region (other region), the maximum density region and the total density busyness are small.

Therefore, when it is judged that the maximum density difference is smaller than the maximum density difference threshold value and the total density busyness is smaller than the total density busyness threshold value, it is judged that a target pixel belongs to other region (page background region, photograph region). When it is not judged that the maximum density difference is smaller than the maximum density difference threshold value and the total density busyness is smaller than the total density busyness threshold value, it is judged that a target pixel belongs to a text region/halftone dot region. Further, when it is judged that the target pixel belongs to the page background region/photograph region, the target pixel is further separated into the photograph region and the page background region according to the maximum density difference and the total density busyness.

Further, when it is judged that the target pixel belongs to the text region/the halftone dot region, the calculated total density busyness is compared with a value obtained by multiplying the maximum density difference with a text/halftone dot judgment threshold value, and the target pixel is separated into a text region or a halftone dot region according to the result of the comparison.

Specifically, as for density distribution of the halftone dot region, the maximum density difference varies according to halftone dots, whereas the maximum density busyness shows density differences in the number corresponding to the number of halftone dots and consequently a ratio of the total density busyness to the maximum density difference gets larger. On the other hand, as for density distribution of a text region, the maximum density difference is large and accordingly the total density busyness is large, but the text region has smaller density change than the halftone dot region, and consequently the text region has smaller total density busyness than the halftone dot region.

Therefore, when the total density busyness is larger than a product of the maximum density difference and the text/halftone dot judgment threshold value, it is judged that the target pixel belongs to the halftone dot region. When the total density busyness is smaller than a product of the maximum density difference and the text/halftone dot judgment threshold value, it is judged that the target pixel belongs to the text region.

The segmentation class signal correction section 14b performs a later-mentioned dilation process and a later-mentioned erosion process with respect to a segmentation class signal, thereby performing a correction process in which a noise such as an isolated point is removed from the segmentation class signal. Then, the segmentation class signal correction section 14b outputs the segmentation class signal having been subjected to the correction process to the black generation and under color removal section 16, the spatial filter process section 17, and the tone reproduction process section 19. The segmentation class signal correction section 14b will be detailed later.

The color correction section 15 removes color impurity on the basis of spectral characteristics of CMY color materials including an unnecessarily absorption component, in order to realize a faithful color reproduction.

The black generation and under color removal section 16 performs (i) a black generation process for generating a black (K) signal from three color (CMY) signals having been subjected to the color correction and (ii) a process for generating new CMY signals by removing portions where original CMY signals overlap. As a result, the three CMY signals are converted into four CMYK signals.

With the use of a digital filter, the spatial filter process section 17 performs a spatial filter process on the basis of a segmentation class signal, with respect to image data which is received in the form of the CMYK signals from the black generation and under color removal section 16. In the spatial filter process, the spatial filter process section 17 corrects a spatial frequency characteristic, so as to reduce blur or granularity deterioration in an output image. The spatial filter process section 17 will be detailed later.

The output tone correction section 18 performs an output tone correction process in which a signal such as a density signal is converted into a halftone dot area ratio that is a characteristic value of the color image output apparatus 30.

The tone reproduction process section 19, as with the spatial filter process section 17, performs a predetermined process with respect to the image data in the form of the CMYK signals, on the basis of the segmentation class signal. The tone reproduction process section 19 performs a tone reproduction process for processing the image data so that the halftone image is reproduced.

For example, a region separated by the segmentation process section 14 into a text region is subjected to the spatial filter process by the spatial filter process section 17 in which the text region is subjected to an edge enhancement process and a high frequency component is emphasized (sharpened) in order to increase reproducibility of black texts or color texts in particular. Then, the text region is subjected to a binarization process or a multi-level dithering process by the tone reproduction process section 19 by use of a screen suitable for reproduction of a high frequency component.

A region separated by the segmentation process section 14 into a halftone dot region is subjected to a low pass filter process by the spatial filter process section 17 in order to remove input halftone components. Then, the halftone dot region is subjected to a multi-level dithering process by use of a dither screen suitable for tone reproduction.

A region separated by the segmentation process section 14 into a photograph region is subjected to a binarization process or a multi-level dithering process by the tone reproduction process section 19 by use of a screen suitable for tone reproduction.

Image data subjected to the above processes is temporarily stored in a storage section (not shown) and then read out at a predetermined timing and output to the color image output apparatus 30.

The color image output apparatus 30 outputs an image corresponding to input image data onto a recording medium (such as paper). A method for forming an image that is employed by the color image output apparatus 30 is not particularly limited, and may be an electrophotography method, an ink-jet method etc. The above processes are controlled by a main control section (CPU (Central Processing Unit)) (not shown).

The operation panel 40 receives input of instructions by a user, and information inputted to the operation panel 40 is transmitted to a main control section (not shown) of the color image processing apparatus 10. An example of the operation panel 40 is a touch panel in which a display section such as a liquid crystal display and an operation section such as setting buttons are integrated with each other. The main control section controls operations of sections of the color image input apparatus 20, the color image processing apparatus 10, and the color image output apparatus 30, on the basis of the information inputted to the operation panel 40.

(2. Signal Processing Circuit 50)

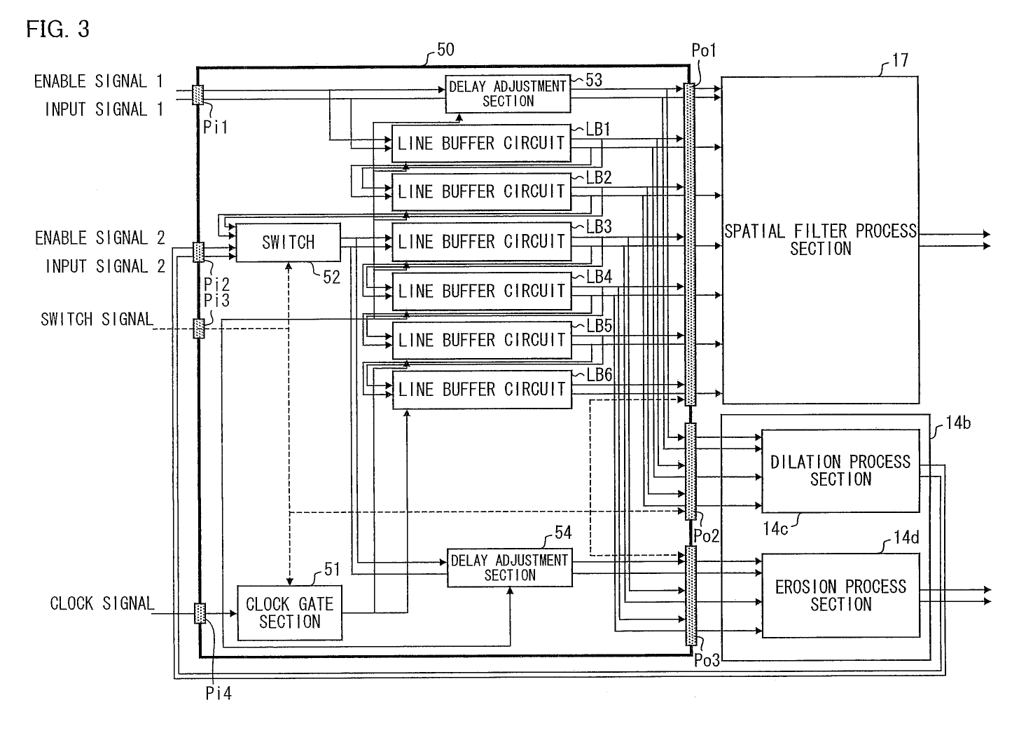

In the present embodiment, the segmentation class signal correction section 14b and the spatial filter process section 17 perform respective processes by use of a common signal processing circuit (signal processing circuit 50 shown in FIG. 3).

FIG. 3 is a block diagram schematically illustrating structures of the signal processing circuit 50, the spatial filter process section 17, and the segmentation class signal correction section 14b.

The spatial filter process section 17 carries out convolution of (i) a block made of pixels including a target pixel in image data to be processed with (ii) pixel values that are filter coefficients assigned to pixels of a matrix of the same size as that of the block. Thus, the spatial filter process section 17 obtains the results of filter processes (enhancement process, smoothing process, or process including characteristics of both enhancement process and smoothing process) on the pixels in the block with respect to the target pixel.

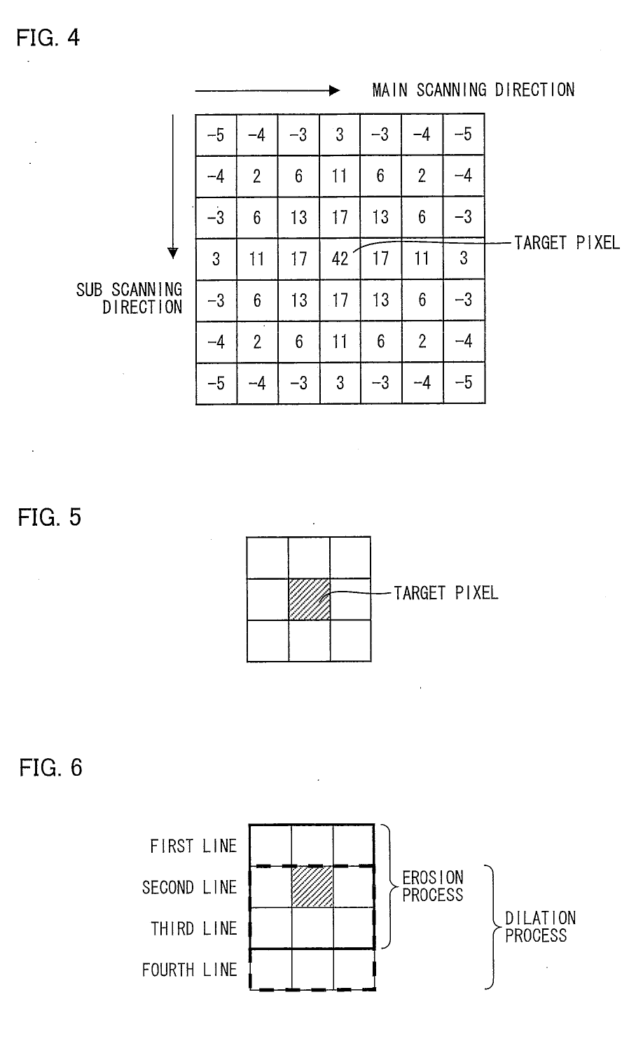

FIG. 4 is an explanatory drawing illustrating a filter used in the spatial filter process section 17. As illustrated in the drawing, in the present embodiment, a filter including 7×7 pixels centering a target pixel is used. Specifically, the spatial filter process section 17 receives image data including 7 pixels in main scanning direction×7 pixels in sub scanning direction (7 lines) from the signal processing circuit 50, multiplies individual pixels of the input image data with filter coefficients corresponding to the respective pixels, calculates the total of the results of the multiplications with respect to each pixel, divides the calculated total by a predetermined value (set according to the total of filter coefficients with respect to each pixel in the filter. 186 in the present embodiment), and regards the resulting value as the result of a filter process with respect to the target pixel.

The spatial filter process section 17 performs the filter process with respect to each of CMYK color components. For this purpose, the spatial filter process section 17 includes four signal processing circuits 50 corresponding to C, M, Y, and K, respectively. However, the present invention is not limited to this and may be arranged such that the spatial filter process section 17 includes only one signal processing circuit 50 which sequentially performs the filter process with respect to C, M, Y, and K one by one.

As illustrated in FIG. 3, the segmentation class signal correction section 14b includes a dilation process section 14c and an erosion process section 14d.

The dilation process section 14c receives a segmentation class signal indicative of 3 pixels in main scanning direction×3 pixels (3 lines) in sub scanning direction including a target pixel from the signal processing circuit 50. With respect to each pixel, the dilation process section 14c performs a dilation process in which values of 8 pixels surrounding a target pixel in the inputted segmentation class signal are checked, and if at least one pixel judged to belong to a text region exists, the target pixel is regarded as belonging to a text region, as illustrated in FIG. 5. Further, the dilation process section 14c inputs, to the signal processing circuit 50, an input signal 2 that is the segmentation class signal having been subjected to the dilation process.

The dilation process section 14c performs a dilation process by regarding the inputted segmentation class signal as binary data (binary image data) indicative of whether it belongs to a text region or not. That is, when the target pixel belongs to the text region, the dilation process is performed by regarding a pixel value of the pixel as 1. When the target pixel does not belong to the text region, the dilation process is performed by regarding a pixel value of the pixel as 0. After the dilation process, there is outputted a segmentation class signal that reflects the result of the dilation process and that indicates which of a text region, a halftone dot region, a photograph region, and page background region each pixel belongs to. More specifically, a pixel regarded as having a pixel value 1 in the dilation process is regarded as belonging to the text region, and a pixel regarded as having a pixel value 0 in the dilation process is regarded as belonging to a region (one of the halftone dot region, the photograph region, and the page background region) indicated by the segmentation class signal received by the dilation process section 14c.

The erosion process section 14d receives, via the signal processing circuit 50, the segmentation class signal having been subjected to the dilation process by the dilation process section 14. With respect to each pixel, the erosion process section 14d performs an erosion process in which when at least one pixel judged as belonging to a page background region exists in 8 pixels surrounding a target pixel, the target pixel is regarded as belonging to a page background region. For example, as illustrated in FIG. 6, the dilation process is performed with respect to a target pixel on the third line on the basis of image data corresponding to the second to fourth lines, and then the erosion process is performed with respect to a target pixel in the second line on the basis of image data corresponding to the first to third lines having been subjected to the dilation process. When a pixel belonging to the halftone dot region exists in 8 pixels surrounding the target pixel, the erosion process section 14d does not change the result of the judgment of the target pixel (does not perform the erosion process). This is intended for avoiding deletion of a text when the text exists on halftone dots (e.g. map). The segmentation class signal having been subjected to the erosion process is outputted to the black generation and under color removal process section 16, the spatial filter process section 17, and the tone reproduction process section 19.

The erosion process section 14d performs the erosion process by regarding the inputted segmentation class signal as binary data (binary image data) indicative of whether it belongs to a page background region or not. That is, when the target pixel belongs to the page background region, the erosion process is performed by regarding a pixel value of the pixel as 1. When the target pixel does not belong to the page background region, the erosion process is performed by regarding a pixel value of the pixel as 0. After the erosion process, there is outputted a segmentation class signal that reflects the result of the erosion process and that indicates which of a text region, a halftone dot region, a photograph region, and page background region each pixel belongs to. More specifically, a pixel regarded as having a pixel value 1 in the erosion process is regarded as belonging to the page background region, and a pixel regarded as having a pixel value 0 in the erosion process is regarded as belonging to a region (one of the text region, the halftone dot region, and the photograph region) indicated by the segmentation class signal received by the erosion process section 14d.

Consequently, it is possible to correct the segmentation class signal so that an isolated point (noise) of a pixel that exists in a text region but that does not belong to the text region, deriving from error in reading an image, is removed. In the present embodiment, the dilation process by the dilation process section 14c is performed before the erosion process by the erosion process section 14c. Alternately, the dilation process by the dilation process section 14c may be performed after the erosion process by the erosion process section 14c. The latter case allows removing an isolated point (noise) of a pixel that exists in a page background region but that belongs to a text region, deriving from error when reading an image.

The segmentation class signal is obtained as a result of judgment with respect to each pixel. Therefore, when there are provided four signal processing circuits 50 corresponding to C, M, Y, and K, respectively, it is suffice that one of the four signal processing circuits 50 performs the dilation process and the erosion process.

The signal processing circuit 50 selectively (alternately) performs (1) a process for outputting each predetermined amount of image data (e.g. 7 pixels in main scanning direction×7 lines in sub scanning direction) from the black generation and under color removal section 16 to the spatial filter process section 17 (filter process mode) and (2) a process for outputting each predetermined amount of a segmentation class signal (e.g. 3 pixels in main scanning direction and 3 lines in sub scanning direction) from the segmentation process section 14 to the dilation process section 14c in the segmentation class signal correction section 14b and for outputting the segmentation class signal having been subjected to the dilation process from the dilation process section 14c to the erosion process section 14d (segmentation class signal correction mode).

The color image processing apparatus 10 includes first storage means (not shown) for temporarily storing image data from the black generation and under color removal section 16, and second storage means (not shown) for temporarily storing a segmentation class signal from the segmentation process section 14. When performing the process (1) (filter process mode), the main control section inputs the image data stored in the first storage means into the signal processing circuit 50. When performing the process (2) (segmentation class signal correction mode), the main control section inputs the segmentation class signal stored in the second storage means into the signal processing circuit 50.

The following specifically explains a structure of the signal processing circuit 50. As illustrated in FIG. 3, the signal processing circuit 50 includes input ports Pi1-Pi4, a clock gate section 51, a switch 52, a delay adjustment section 53, a delay adjustment section 54, line buffer circuits LB1-LB6, and output ports Po1-Po3.

The delay adjustment section 53 delays (i) an input signal 1 (image data from the black generation and under color removal section 16 in the filter process mode, a segmentation class signal from the segmentation process section 14 in the segmentation class signal correction mode) corresponding to 1 line that is inputted from the input port Pi1 and (ii) an enable signal 1 inputted from the main control section so that the input signal 1 and the enable signal 1 are synchronized with output signals from line buffer circuits (line buffer circuits LB1-LB6 in the filter process mode, line buffer circuits LB1 and LB2 in the segmentation class signal correction mode), and outputs the input signal 1 and the enable signal 1 that are thus delayed to the output ports Po1 and Po2. The output port Po1 is connected with the spatial filter process section 17, and the output port Po2 is connected with the dilation process section 14c.

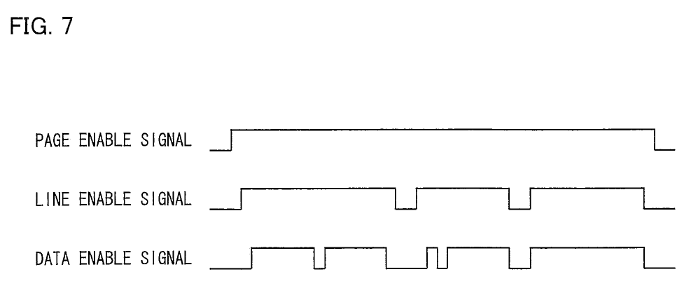

The enable signal includes three control signals: a page enable signal indicative of an effective period for one page; a line enable signal indicative of an effective period for one line; and a data enable signal indicative of effectiveness/ineffectiveness of data. The signal processing circuit 50, the spatial filter process section 17, and the segmentation class signal correction section 14b perform controls according to the enable signal. FIG. 7 is a timing chart illustrating timings of the three enable signals. The asserted period of the page enable signal (period in which the page enable signal is at a high level) indicates one page of an image. The asserted period of the line enable signal indicates one line. The asserted period of the data enable signal indicates one data.

The delay adjustment section 54 delays an input signal 2 (segmentation class signal having been subjected to the dilation process by the dilation process section 14c) inputted via the switch 52 and an enable signal 2 so that the input signal 2 and the enable signal 2 are synchronized with output signals from the line buffer circuits LB3 and LB4, and outputs the input signal 2 and the enable signal 2 that are thus delayed to the output port Po3. The output port Po3 is connected with the erosion process section 14d.

In response to a switch signal inputted from the input port Pi3 from the main control section, the switch 52 switches connection states of individual members of the signal processing circuit 50 between (1) a state intended for outputting image data to the spatial filter process section 17 (filter process mode) and (2) a state intended for outputting a segmentation class signal to the segmentation class signal correction section 14b (segmentation class signal correction mode).

Specifically, in the filter process mode (e.g. when the switch signal is “0”), the switch 52 inputs image data and an enable signal from the line buffer circuit LB2 into the line buffer circuit LB3. In this case, the line buffer circuits LB1-LB6 and the delay adjustment section 53 serve as seven line buffers that output image data corresponding to seven lines in sub scanning direction, inputted from the black generation and under color removal section 16, in such a manner that the image data are synchronized with each other.

On the other hand, in the segmentation class signal correction mode (e.g. when the switch signal is “1”), the switch 52 inputs the segmentation class signal (input signal 2) having been subjected to the dilation process and the enable signal 2, both of which signals are inputted from the dilation process section 14c via the input port Pi2, into the line buffer circuit LB3. In this case, the line buffer circuits LB1 and LB2 and the delay adjustment section 53 serve as three line buffers that output segmentation class signals inputted from the segmentation process section 14, in such a manner that the segmentation class signals are synchronized with one another. The line buffer circuits LB3 and LB4 and the delay adjustment section 54 serve as three line buffers that output segmentation class signals inputted from the dilation process section 14c, in such a manner that the segmentation class signals having been subjected to the dilation process are synchronized with one another.

In response to a switch signal (register signal) inputted from the input port Pi3 from the main control section, the clock gate section 51 blocks inputs of clock signals into the line buffer circuits LB5 and LB6 during a period when the segmentation class signal correction mode is selected, and stops operations of the line buffer circuits LB5 and LB6. That is, since the line buffer circuits LB5 and LB6 are not used in the segmentation class signal correction mode, inputs of clock signals into the line buffer circuits LB5 and LB6 are blocked, so that the operations of the line buffer circuits LB5 and LB6 are stopped. This reduces power consumption.

In the present embodiment, image data corresponding to 7 lines are used in the spatial filter process. However, the present invention is not limited to this. For example, in a case of using image data corresponding to 15 lines, the signal processing circuit 50 is arranged to include line buffer circuits for 14 lines. In this case, the dilation process and the erosion process require line buffer circuits for 4 lines in total, and therefore it is possible to stop supply of a clock signal to 10 line buffer circuits in the segmentation class signal correction mode. This allows further reducing power consumption. Further, in the present embodiment, a text region is subjected to the dilation process and a page background region is subjected to the erosion process. However, the present invention is not limited to this, and may be arranged so that a text region and a photograph region are subjected to the dilation process and a page background region is subjected to the erosion process. In this case, the dilation process and the erosion process require line buffer circuits for 8 lines in total. When using image data corresponding to 15 lines, it is possible to stop supply of a clock signal to 6 line buffer circuits in the segmentation class signal correction mode.

In the present embodiment, operation of the clock gate section 51 is controlled in response to a switch signal for switching operation of the switch 52. Alternatively, a signal (register signal) different from the switch signal may be used.

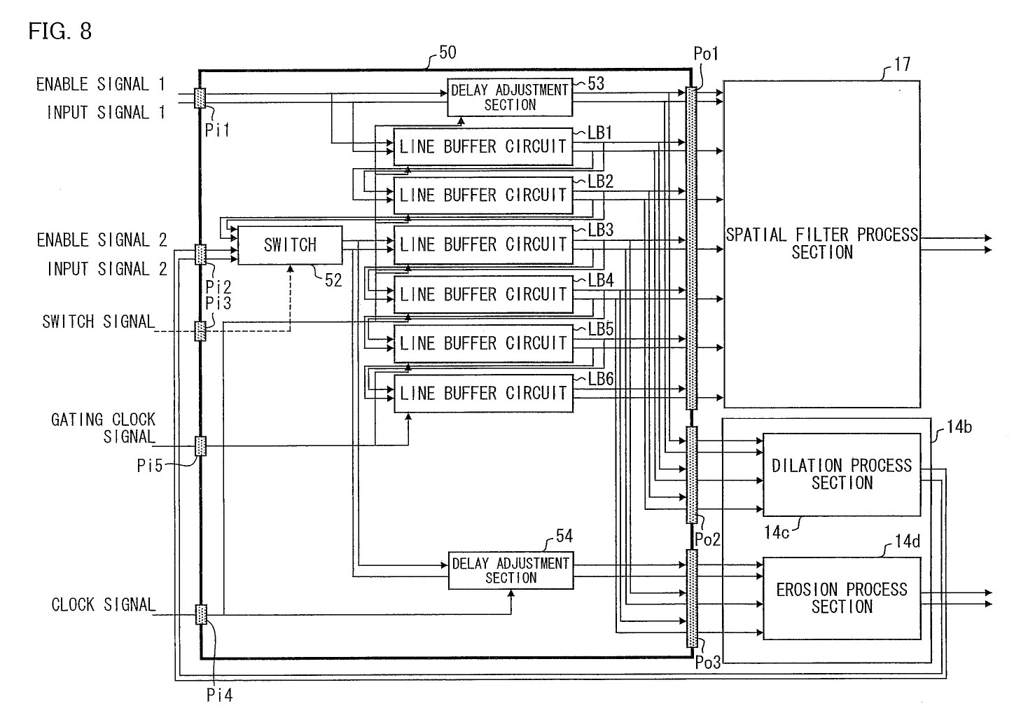

In the present embodiment, inputting/blocking of a clock signal into the line buffer circuits LB5 and LB6 are controlled by the clock gate section 51, but the present invention is not limited to this. For example, as illustrated in FIG. 8, the present invention may be arranged so that the clock gate section 51 is omitted, and a signal (gating clock signal) different from clock signals to the line buffer circuits LB1-LB4 are used as clock signals to be inputted to the line buffer circuits LB5 and LB6, and switching means (not shown) provided outside the signal processing circuit 50 prevents a gating clock signal from being inputted into the signal processing circuit 50 during a period in which the segmentation class signal correction mode is selected.

Each of the line buffer circuits LB1-LB6 temporarily stores an input signal corresponding to 1 line, and output the signal with predetermined timing. Output terminals of the line buffer circuits LB1 and LB2 are connected with the output ports Po1 and Po2, output terminals of the line buffer circuits LB3 and Lb4 are connected with the output ports Po1 and Po3, and output terminals of the line buffer circuits LB5 and LB6 are connected with the output port Po1. The line buffer circuits LB1-LB6 are detailed later.

Consequently, in the case of the filter process mode, image data corresponding to first line that is inputted from the black generation and under color removal section 16 and an enable signal inputted from the main control section are inputted to the line buffer circuit LB1, image data corresponding to second line and an enable signal are inputted to the line buffer circuit LB2, image data corresponding to third line and an enable signal are inputted to the line buffer circuit LB3, image data corresponding to fourth line and an enable signal are inputted to the line buffer circuit LB4, image data corresponding to fifth line and an enable signal are inputted to the line buffer circuit LB5, image data corresponding to sixth line and an enable signal are inputted to the line buffer circuit LB6, and image data corresponding to seventh line and an enable signal are inputted to the delay adjustment section 53. The image data corresponding to the respective lines and the enable signals are outputted to the spatial filter process section 17 via the output port Po1 with their timings synchronized.

In the case of the segmentation class signal correction mode, a segmentation class signal corresponding to the first line that is inputted from the segmentation process section 14 and an enable signal inputted from the main control section are inputted to the line buffer circuit LB1, a segmentation class signal corresponding to the second line and an enable signal are inputted to the line buffer circuit LB2, and a segmentation class signal corresponding to the third line and an enable signal are inputted to the delay adjustment section 53. The segmentation class signals corresponding to the respective lines are outputted to the dilation process section 14c via the output port Po2 with their timings synchronized. Further, segmentation class signals having been subjected to the dilation process, that are outputted from the dilation process section 14c, and enable signals are inputted as follows; a segmentation class signal corresponding to the first line and an enable signal are inputted to the line buffer circuit LB3, a segmentation class signal corresponding to the second line and an enable signal are inputted to the line buffer circuit LB4, and the segmentation class signal corresponding to the third line and an enable signal are inputted to the delay adjustment section 54. These segmentation class signals corresponding to the respective lines and the enable signals are outputted to the erosion process section 14d via the output port Po3 with their timings synchronized.

In a case where the enable signal is indicative of the filter process mode, the spatial filter process section 17 performs a filter process, whereas in a case where the enable signal is indicative of the segmentation class signal correction mode, the spatial filter process section 17 does not perform the filter process even when image data is inputted. Whether the enable signal is indicative of the filter process mode or the segmentation class signal correction mode may be determined according to the length of a period in which the data enable signal is asserted (period in which the data enable signal is at a high level). Further, in addition to the three kinds of enable signals mentioned above, an enable signal indicative of whether the mode is the filter process mode or the segmentation class signal correction mode may be used.

In the case where the enable signal is indicative of the segmentation class signal correction mode, the dilation process section 14c performs the dilation process, whereas in the case where the enable signal is indicative of the filter process mode, the dilation process section 14c does not perform the dilation process even when the segmentation class signal is inputted. Similarly, in the case where the enable signal is indicative of the segmentation class signal correction mode, the erosion process section 14d performs the erosion process, whereas in the case where the enable signal is indicative of the filter process mode, the erosion process section 14d does not perform the erosion process even when the segmentation class signal is inputted. However, the present invention is not limited to this, and may be arranged so that in the case where the enable signal is indicative of the segmentation class signal correction mode, image data is not outputted from the output port Po1 to the spatial process section 17, whereas in the case where the enable signal is indicative of the filter process mode, a segmentation class signal is not outputted from the output port Po2 to the dilation process section 14c and a segmentation class signal is not outputted from the output port Po3 to the erosion process section 14d.

(3. Line Buffer Circuits LB1-LB6)

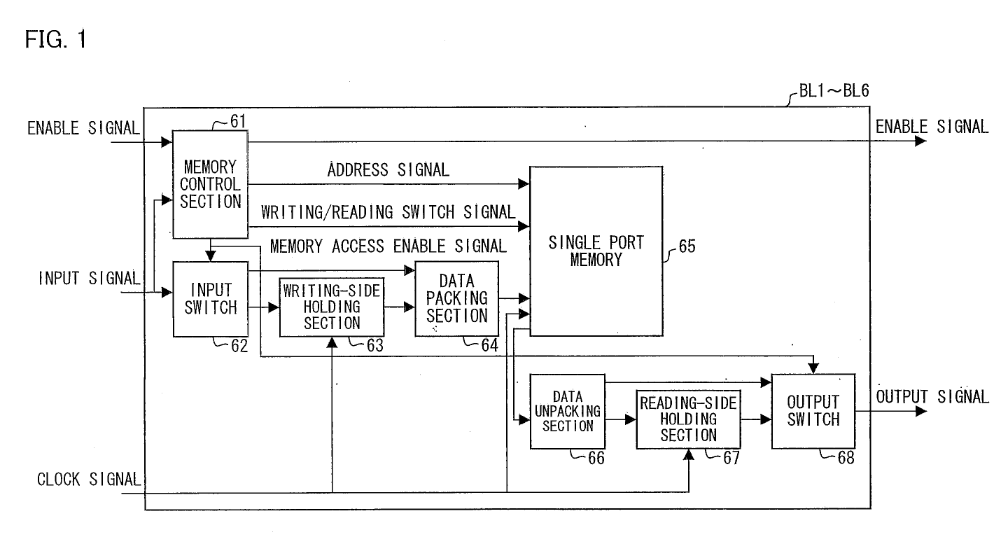

The following explains structures of the line buffer circuits LB1-LB6. FIG. 1 is a block diagram illustrating a configuration of the line buffer circuit LB1. The line buffer circuits LB2-LB6 have the same configurations as that of the line buffer circuit LB1.

As illustrated in the drawing, the line buffer circuit LB1 includes a memory control section 61, an input switch 62, a writing-side holding section 63, a data packing section 64, a single port memory 65, a data unpacking section 66, a reading-side holding section 67, and an output switch 68.

The single port memory 65 is a single port memory in which an input signal (image data or a segmentation class signal) corresponding to 1 line is stored.

In response to an enable signal, the memory control section 61 generates control signals for controlling individual sections of the line buffer circuit LB1, i.e. an address signal indicative of an address with which data is written into, or with which data is read from, the single port memory 65; a writing/reading switch signal for switching between a writing process and a reading process with respect to the single port memory 65 (memory writing enable signal, memory reading enable signal); and a memory access enable signal indicative of effectiveness/ineffectiveness of an access to the single port memory 65.

The input switch 62 is a switch for switching destinations of an input signal between data in odd number and data in even number in accordance with the control signal inputted from the memory control section 61. Specifically, the input switch 62 outputs an input signal in odd number (pixel in odd number) to the writing-side holding section 63, and outputs an input signal in even number (pixel in even number) to the data packing section 64.

The writing-side holding section 63 temporarily stores an input signal in odd number that is inputted from the input switch 62. The writing-side holding section 63 is made of a flip-flop for example.

The data packing section 64 packs (i) an input signal in odd number that is held by the writing-side holding section 63 with (ii) an input signal in even number that is inputted from the input switch 62.

The data unpacking section 66 unpacks data read out from the single port memory 65 into data in odd number and data in even number, reads out the data in even number and outputs the data to the reading-side holding section 67, and outputs the data in odd number to the output switch 68.

The reading-side holding section 67 temporarily stores data in even number that is inputted via the data unpacking section 66. The reading-side holding section 67 is made of a flip-flop for example.

In response to the control signal from the memory control section 61, the output switch 68 appropriately selects data in odd number inputted from the output switch 68 and data in even number inputted from the reading-side holding section 67 so that the data are outputted in the same order as the order when the data were inputted to the input switch 62 (FIFO (First-in-First-out)).

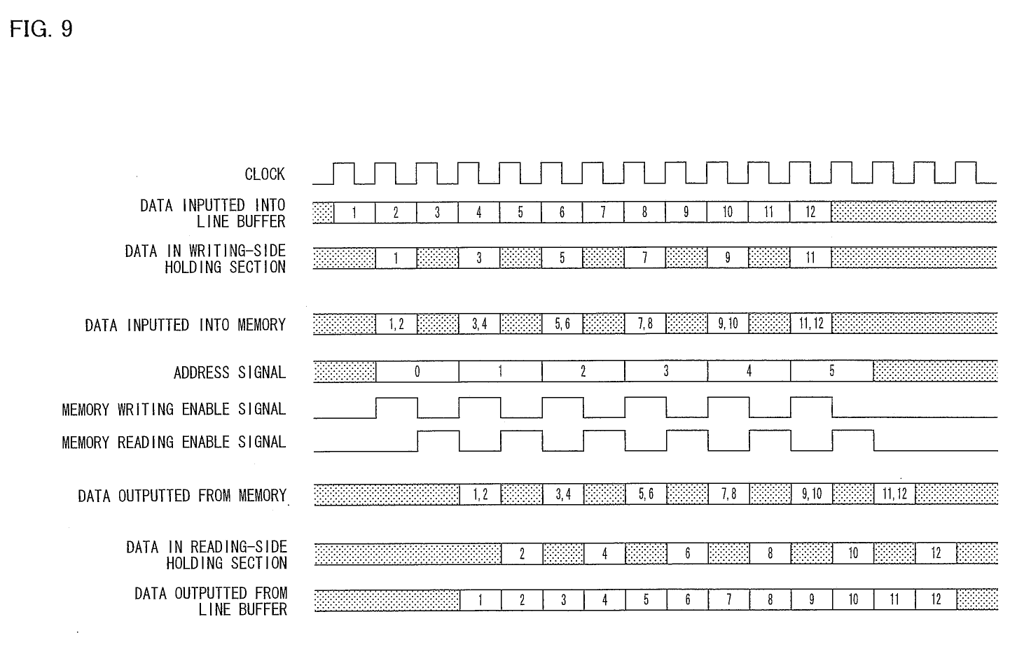

FIG. 9 is a timing chart illustrating a process of writing data corresponding to 12 pixels in 1 line into the single port memory 65, and a process of reading the data from the single port memory 65.

When data in odd number is inputted, the memory control section 61 causes the data in odd number to be transmitted from the input switch 62 to the writing-side holding section 63, and causes the data to be temporarily stored in the writing-side holding section 63.

Thereafter, when data in even number is inputted next to the data in odd number, the memory control section 61 causes the data in even number to be transmitted from the input switch 62 to the data packing section 64, and causes the data in odd number that has been temporarily stored in the writing-side holding section 63 to be transmitted to the data packing section 64.

Subsequently, the memory control section 61 causes the data packing section 64 to pack the data in odd number that has been inputted from the writing-side holding section 63 with the data in even number that has been inputted from the input switch 62. Then, the memory control section 61 outputs an address signal indicative of an address with which the data is written and a memory writing enable signal for enabling a writing operation, and causes the data packed by the data packing section 64 to be written in the single port memory 65.

Thus, the data corresponding to two pixels are written by one access to the single port memory 65.

Further, when reading out the data written in the single port memory 65, the memory control section 61 outputs an address signal indicative of an address of data to be read and a memory reading enable signal for enabling a reading operation, and reads data corresponding to 2 pixels at a time and sends the data to the data unpacking section 66.

The memory control section 61 causes the data corresponding to a pixel in odd number out of the data corresponding to 2 pixels that are read from the single port memory 65 to be outputted from the data unpacking section 66 to the output switch 68, and causes the data corresponding to a pixel in even number to be outputted to the reading-side holding section 67 and stored there. Further, the memory control section 61 causes the data of a pixel in even number that is stored in the reading-side holding section 67 to be outputted from the reading-side holding section 67 to the output switch 68 in accordance with timing of output of the data of a pixel in odd number from the output switch 68.

Further, the memory control section 61 controls operation of the output switch 68 so that the data of a pixel in odd number that is inputted from the data unpacking section 66 is outputted and then the data of a pixel in even number that is inputted from the reading-side holding section 67 is outputted.

Thus, the data corresponding to two pixels are read out by one access to the single port memory 65. A time from writing data in the single port memory 65 to starting of reading the data is set differently with respect to each line buffer circuit so that timings of outputs from the individual line buffer circuits are synchronized.

Thus, in the present embodiment, writing of data corresponding to two pixels and reading of data corresponding to two pixels are performed alternately. That is, data corresponding to two pixels are read out from the single port memory 65 with timing of input of data in odd number to the line buffer circuit, and data corresponding to two pixels are written into the single port memory 65 with timing of input of data in even number to the line buffer circuit.

This allows a high-speed FIFO process in the single port memory 65. A single port memory has only one terminal for accessing a memory, and therefore only one of writing and reading can be performed in one cycle (one access). Consequently, when performing a writing process and a reading process, conventional arts require two times as many accesses as the number of pixels (the number of data). In contrast thereto, the present embodiment is designed such that data is written in or read out with respect to every two pixels so that the number of accesses is reduced to half of the number of accesses in the conventional arts, and that data in odd number is input in the line buffer circuit and then read out from the single port memory 65 before data in even number is input, so that the process time for writing and reading can be reduced to half of that of the conventional arts.

In the example of FIG. 9, an explanation was made as to a case where data is written into or read out from the single port memory 65 with respect to every two pixels. However, the number of pixels (the number of data) to be written into or read out from the single port memory 65 in each access is not limited to two.

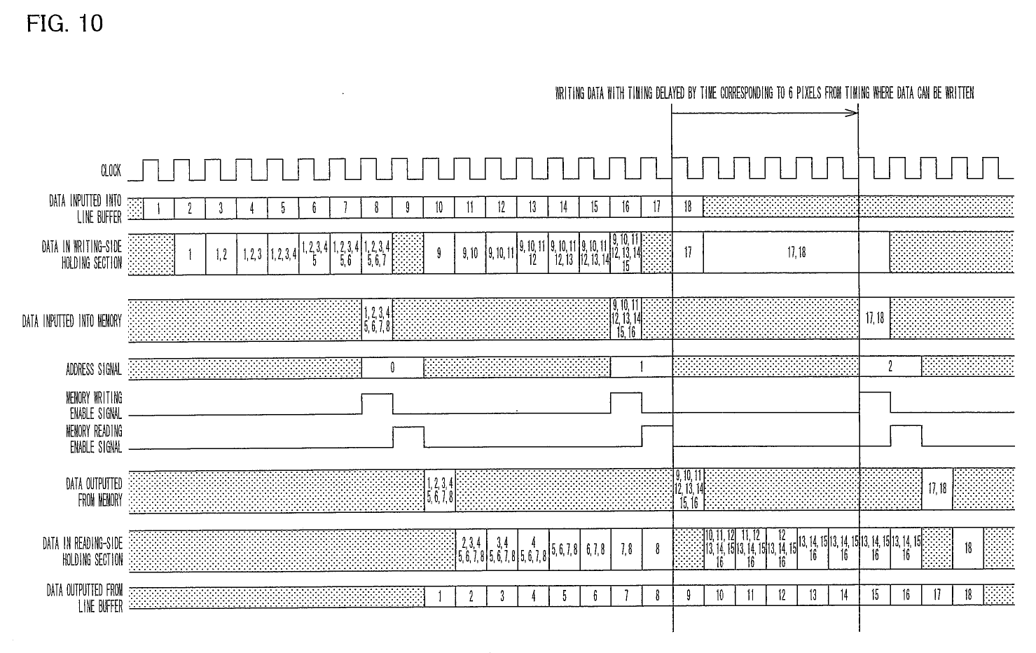

FIG. 10 is a timing chart in a case where the number of pixels (the number of data) to be written into or read out in one access is 8. In this case, data corresponding to first to seventh pixels are temporarily stored in the writing-side holding section 63, and when data corresponding to eighth pixel is inputted, the data corresponding to 8 pixels are packed by the data packing section 64 so that the data are written into the single port memory 65 in one access.

Further, while data corresponding to first to seventh pixels are inputted, data corresponding to 8 pixels are read out from the single port memory 65 in one access. Out of the data corresponding to 8 pixels thus read out, the data corresponding to first pixel is transmitted from the data unpacking section 66 to the output switch 68 and outputted, and the data corresponding to second to eighth pixels are temporarily stored in the reading-side holding section 67 and then the data is transmitted one by one to the output switch 68 and outputted there, in the order of the data corresponding to second pixel and thereafter.

Thus, by increasing the number of pixels to be written into or read out in one access, it is possible to reduce the number of accesses to the single port memory 65. However, as the number of pixels to be written into or read out in one access increases, the amount of data held by the writing-side holding section 63 and the reading-side holding section 67 increases and management of data outputted from the output switch 68 gets complicated. Therefore, it is preferable that the number of pixels to be written into or read out in one access is set appropriately in accordance with capacities of the writing-side holding section 63 and the reading-side holding section 67, performance of the memory control section 61, etc.

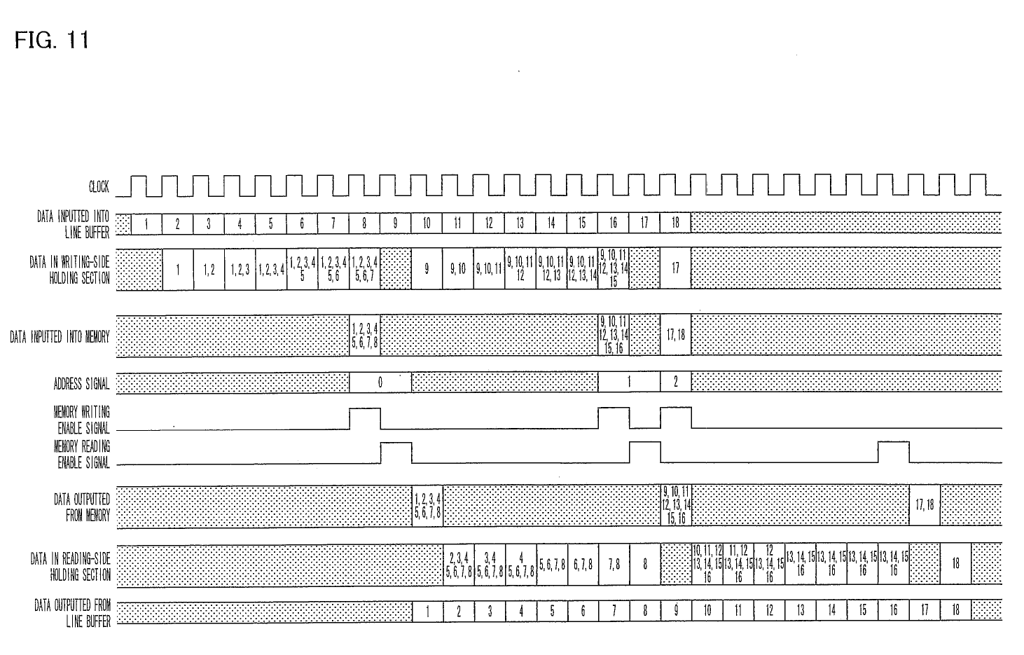

FIG. 10 illustrates an example in a case where one line consists of data corresponding to 18 pixels. Although data corresponding to seventeenth and eighteenth pixels can be written in the single port memory 65 at the time when the two data are inputted, the two data are written with timing delayed by a time required for inputting data corresponding to 6 pixels after the input of the data corresponding to eighteenth pixel, in order to cause the input of the two data to be in accordance with timing of reading data corresponding to other pixels from the single port memory 65. However, the present invention is not limited to this and may be arranged so that data corresponding to seventeenth and eighteenth pixels are written into the single port memory 65 when the data corresponding to the eighteenth pixel are inputted, as illustrated in FIG. 11 for example.

As described above, the digital color multifunction printer 1 of the present embodiment is designed such that, in the line buffer circuits LB1 to LB6, when data is written into the single port memory 65, data corresponding to predetermined number of pixels that are packed by the data packing section 64 are written together into the single port memory 65, and when data are read out from the single port memory 65, data corresponding to predetermined number of pixels are read out together from the single port memory 65, and after the data corresponding to predetermined number of pixels are written into the single port memory 65, the data are read out from the single port memory 65 before next data corresponding to predetermined number of pixels that are to be written in the single port memory 65 are inputted.

This allows making the size of a circuit smaller than that of a line buffer circuit including a dual port memory, and allows the writing process and the reading process to be performed with a time similar to that of the line buffer circuit including the dual port memory. Further, this allows reducing the number of access to a memory compared with a conventional line buffer circuit including a single port memory or a dual port memory, and consequently power consumption can be reduced.

Further, the digital color multifunction printer 1 of the present embodiment is designed such that it includes the line buffer circuits LB1 to LB6 and the delay adjustment section 53, and when the spatial filter process is performed, image data corresponding to 6 lines that are stored in the line buffer circuits LB1 to LB6 respectively are synchronized with image data corresponding to 1 line that is inputted in the delay adjustment section 53 and the data thus synchronized are outputted to the spatial filter process section 17, and when the dilation process is performed, image data corresponding to 2 lines that are stored in the line buffer circuits LB1 and LB2 are synchronized with image data corresponding to 1 line that is inputted in the delay adjustment section 53 and the data thus synchronized are outputted to the dilation process section 14c.

This allows reducing the size of a circuit, compared with a case where signal processing sections corresponding to the spatial filter process section 17 and the dilation process section 14c are separately provided.

Further, in a case where the erosion process is performed after the dilation process, out of image data corresponding to 3 lines having been subjected to the dilation process, image data corresponding to 2 lines are inputted to the line buffer circuits LB3 and LB4 and the delay adjustment section 54, and the image data corresponding to 3 lines are synchronized and outputted to the erosion process section 14d.

This allows reducing the size of a circuit, compared with a case where signal processing sections corresponding to the first image process section, the dilation process section 14c, and the erosion process section 14d are separately provided.

In the present embodiment, an explanation was made as to a case where the present invention is applied to a digital multifunction printer. However, application of the present invention is not limited to this. For example, the present invention may be applied to a monochrome multifunction printer. Further, the present invention may be applied to an apparatus including one of a copier function, a printer function, a facsimile transmission function, a scan to e-mail function etc., and may be an apparatus including at least two of these functions.

For example, a communication device including a modem or a network card may be added to the configuration of the digital color multifunction printer 1 in order to allow facsimile transmission. In this case, when carrying out facsimile transmission, the digital color multifunction printer 1 causes the communication device to carry out a transmission procedure with a destination to secure a state where transmission can be performed, and then the digital color multifunction printer 1 reads out, from the memory, image data encoded in a predetermined format (image data scanned by a scanner) and carries out necessary processing such as conversion of the encoding format, and then sequentially transmits the image data via a communication line to the destination.

Further, when carrying out facsimile reception, the digital color multifunction printer 1 causes the communication device to carry out a communication procedure and receives the image data from an originating communication device so as to input the image data to the color image processing apparatus 10. The color image processing apparatus 10 subjects the received image data to an encoding/decoding process, a rotation process, a rotation process, and a resolution conversion process if necessary, and is subjected to an output tone correction process and a tone reproduction process, and is output from the color image output apparatus 30.

Further, the digital color multifunction printer 1 may carry out, via a network card and a LAN cable, data communications with a computer or other digital multifunction printer connected with a network.

### Embodiment 2

The following explains another embodiment of the present invention. For convenience of explanation, members having the same functions as those of Embodiment 1 are given the same references numerals and explanations thereof are omitted here.

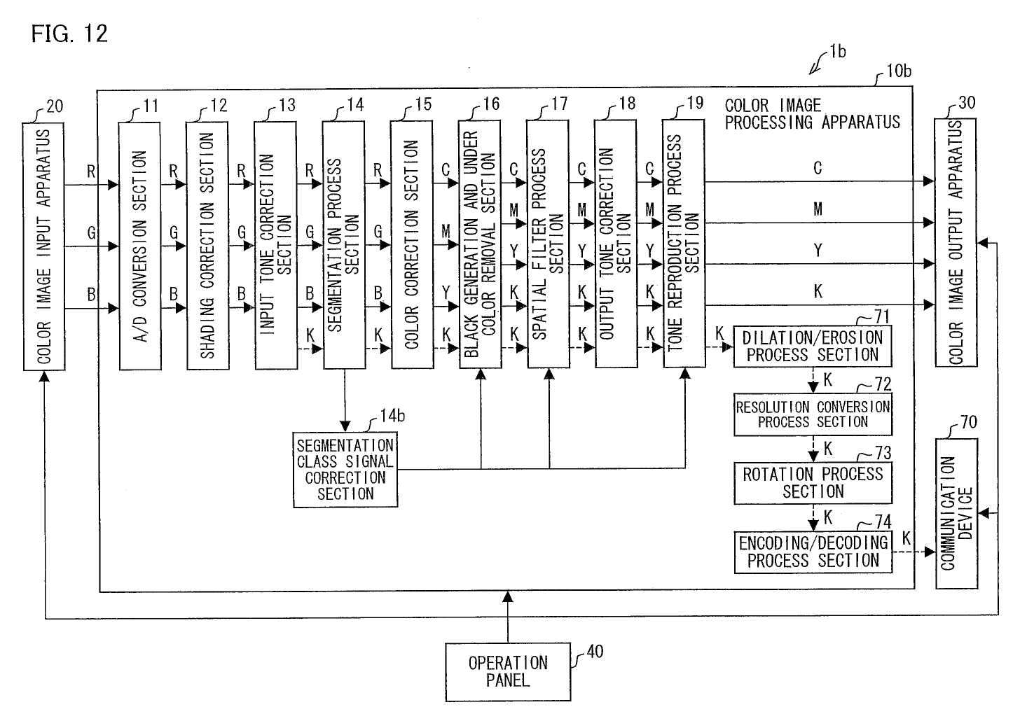

FIG. 12 is a block diagram schematically illustrating a structure of a digital color multifunction printer (image processing apparatus, image forming apparatus) 1b of the present embodiment. As illustrated in the drawing, the digital color multifunction printer 1b includes a color image processing apparatus 10b instead of the color image processing apparatus 10 in the digital color multifunction printer 1 of Embodiment 1. Further, the digital color multifunction printer 1b includes, in addition to the configuration of the digital color multifunction printer 1 of Embodiment 1, a communication device 70.

The color image processing apparatus (image processing apparatus) 10b includes not only the configuration of the color image processing apparatus 10 of Embodiment 1 but also a dilation/erosion process section 71, a resolution conversion process section 72, a rotation process section 73, and an encoding/decoding process section 74.

When carrying out facsimile transmission/reception (when a mode for facsimile transmission is selected or when a reception signal of a facsimile is received), the color image processing apparatus 10b carries out processes by the input tone correction section 13b and thereafter in a manner partially different from that of Embodiment 1. FIG. 12 illustrates, by use of a broken line, a flow of data when carrying out facsimile transmission/reception. The following explains a process when carrying out facsimile transmission/reception.

The A/D conversion section converts color analog signals into digital signals.

The shading correction section 12 removes, from the digital color signals from the A/D conversion section 11, various distortions produced in an illumination system, an image focusing system, and an image sensing system when reading an image.

The input tone correction section 13b corrects non-linearity of tones of image data having been subjected to the shading correction process (converts the image data into density data). This process is performed with reference to a LUT (Look Up Table) for example. Further, color image data is converted into a luminance signal (K) by use of matrix calculation for example.

The segmentation process section 14 separates each pixel of image data from the input tone correction section into either one of a text region, a halftone dot region, or a photograph (continuous tone) region. On the basis of a result of the separation, the segmentation process section 14 outputs a segmentation class signal, indicating which region a pixel of the image data belongs to, to the spatial filter process section 17 and the tone reproduction process section 19 through the segmentation class signal correction section 14b. When carrying out facsimile transmission/reception, the segmentation class signal correction section 14b outputs a segmentation class signal as received from the segmentation process section 14 to the spatial filter process section 17 and the tone reproduction process section 19 without any modification. Alternatively, when carrying out facsimile transmission/reception, the segmentation process section 14 does not perform the segmentation process section. Further, the segmentation process section 14 outputs the signal from the input tone correction section 13b to the subsequent spatial filter process section 17 without any modification.

When carrying out facsimile transmission/reception, the color correction section 15 and the black generation and under color removal section 16 do not perform the color correction process and the black generation and under color removal process, and output input data to the spatial filter process section 17 without any modification.

With the use of a digital filter, the spatial filter process section 17 performs a spatial filter process on the basis of a segmentation class signal, with respect to image data outputted from the segmentation process section 14. In the spatial filter process, the spatial filter process section 17 corrects a spatial frequency characteristic, so as to reduce blur or granularity deterioration in an output image. The spatial filter process is performed in a manner similar to that of Embodiment 1.

When carrying out facsimile transmission/reception, the output tone correction section 18 outputs input data to the tone reproduction process section 19 without any modification.

The tone reproduction process section 19 converts 8-bit image data in each pixel output from the spatial filter process section 17 into binary image data by use of an error diffusion method. This process is performed according to a segmentation class signal output from the segmentation process section 14. For example, a region separated by the segmentation process section 14 into a text region is subjected to a binarization process suitable for reproduction of high frequency. A region separated by the segmentation process section 14 into a photograph region is subjected to a binarization process suitable for tone reproduction.

The dilation/erosion process section 71 performs the dilation process/erosion process on binary image data from the tone reproduction process section 19 so as to remove noises. Methods for the dilation process and the erosion process are the same as the methods employed in the dilation process section 14c and the erosion process section 14d in Embodiment 1.

The resolution conversion process section 72 subjects image data to the resolution conversion process if necessary. The rotation process section 73 subjects image data to the rotation process if necessary. The encoding/decoding process section 74 encodes image data in a predetermined format and temporarily stores the image data in a memory (not shown).

When carrying out facsimile transmission/reception, the main control section sets a value indicative of a transmission/reception mode of a facsimile in a register (not shown). Further, the main control section generates a switch signal for switching the signal processing circuit 50 between a state for outputting image data to the spatial filter process section 17 (filter process mode) and a state for outputting image data to the dilation/erosion process section 71 (dilation/erosion process mode), and outputs the switch signal to the signal processing circuit 50. The operation of the signal processing circuit 50 is substantially the same as that in Embodiment 1 and explanation thereof is omitted here.

The communication device 70 performs communications with other device connected with the digital color multifunction printer 1b via a communication line. In the present embodiment, facsimile transmission/reception is performed via the communication device 70.

When carrying out facsimile transmission, the main control section causes the communication device 70 to carry out a transmission procedure with a destination to secure a state where transmission can be performed, and then the main control section reads out, from the memory, image data encoded in a predetermined format and carries out necessary processing such as conversion of the encoding format, and then sequentially transmits the image data from the communication device 70 to the destination via a communication line.

Further, when carrying out facsimile reception, the main control section causes the communication device 70 to carry out a communication procedure and receives the image data encoded in the predetermined format from an originating communication device so as to input the image data to the color image processing apparatus 10b. Further, the main control section causes the encoding/decoding process section 74 to carry out the decoding process on the image data so as to reproduce a document image that has been transmitted as a page image. Further, the main control section controls the resolution conversion process section 72 and the rotation process section 73 so that they perform the resolution conversion process and the rotation process, respectively, on the document image in accordance with the specification of the color image output apparatus 30, and the document image is outputted to the color image output apparatus 30. Since data transmitted via facsimile has been binarized, the data is outputted to the color image output apparatus 30. The color image output apparatus 30 forms an image on a recording material according to image data of the document image.

As described above, the digital color multifunction printer 1b of the present embodiment includes the line buffer circuits LB1 to LB6 and the delay adjustment section 53. When performing the spatial filter process, image data corresponding to 6 lines that are stored in the line buffer circuits LB1 to LB6 are synchronized with image data corresponding 1 line that is inputted in the delay adjustment section 53, and the image data thus synchronized are outputted to the spatial filter process section 17. When performing the dilation process, image data corresponding to 2 lines that are stored in the line buffer circuits LB1 and LB2 are synchronized with image data corresponding to 1 line that is inputted in the delay adjustment section 53, and the image data thus synchronized are outputted to the dilation process section 14c.

This yields substantially the same effect as the effect yielded by the digital color multifunction printer 1 of Embodiment 1.

In the above embodiments, an explanation was made as to a case where image data from the signal processing circuit 50 is subjected to the spatial filter process and the dilation/erosion process. However, the present invention is not limited to this, and may be applied to an image processing apparatus including a plurality of image processing sections each performing an image process by use of image data with different number of lines. For example, at least two of a filter process, a segmentation process, a rotation process, a zooming process, and a labeling process (a process for giving to a target pixel a label indicative of a characteristic of the target pixel on the basis of a relationship between the pixel value of the target pixel and pixels values of adjacent pixels) may be performed by use of an output from the signal processing circuit 50.

Each section (block) of the color image processing apparatus 10 included in the digital color multifunction printer 1 may be realized by software by using a processor such as a CPU. Namely, the digital color multifunction printer 1 may include: CPUs (central processing unit) for executing a program for realizing functions of each section; ROMs (read only memory) that store the program; RAMs (random access memory) that develop the program; storage devices (storage mediums) such as a memory in which the program and various data are stored; and the like. In this case, the object of the present invention can be realized in such a manner that the digital color multifunction printer 1 is provided with a computer-readable storage medium for storing program codes (such as executable program, intermediate code program, and source program) of programs of the color image processing apparatus 10 which programs serve as software for realizing the functions, and a computer (alternatively, CPU or MPU) reads out and executes the program codes stored in the storage medium.

The storage medium is, for example, tapes such as a magnetic tape and a cassette tape, or discs such as magnetic discs (e.g. a floppy disc® and a hard disc), and optical discs (e.g. CD-ROM, MO, MD, DVD, and CD-R). Further, the storage medium may be cards such as an IC card (including a memory card) and an optical card, or semiconductor memories such as mask ROM, EPROM, EEPROM, and flash ROM.

Further, the color image processing apparatus 10 may be arranged so as to be connectable to a communication network so that the program code is supplied to the color image processing apparatus 10 through the communication network. The communication network is not particularly limited. Examples of the communication network include the Internet, intranet, extranet, LAN, ISDN, VAN, CATV communication network, virtual private network, telephone network, mobile communication network, and satellite communication network. Further, a transmission medium that constitutes the communication network is not particularly limited. Examples of the transmission medium include (i) wired lines such as IEEE 1394, USB, power-line carrier, cable TV lines, telephone lines, and ADSL lines and (ii) wireless connections such as IrDA and remote control using infrared ray, Bluetooth®, 802.11, HDR, mobile phone network, satellite connections, and terrestrial digital network. Note that the present invention can be also realized by the program codes in the form of a computer data signal embedded in a carrier wave, which is the program that is electrically transmitted.

Further, each block of the color image processing apparatus 10 is not necessarily realized by software, but may be realized by hardware logic, and may be realized by a combination of hardware carrying out some of the processes and computing means controlling the hardware and executing program code for the other processes.

The line buffer circuit of the present invention is a line buffer circuit, including: a single port memory in which image data corresponding to 1 line is stored; and a memory control section for controlling writing and reading of data to and from the single port memory, the line buffer circuit including: a data packing section for packing a plurality of data corresponding to predetermined number of pixels, respectively, the data being to be written into the single port memory; a data unpacking section for unpacking data corresponding to predetermined number of pixels, respectively, that is read out from the single port memory, into a plurality of data each corresponding to a pixel; and a data output section for sequentially outputting the plurality of data each corresponding to a pixel in such a manner that each data is outputted with respect to each pixel, the plurality of data being obtained as a result of unpacking by the data unpacking section, when writing data into the single port memory, the memory control section writing together, into the single port memory, the plurality of data corresponding to predetermined number of pixels that are packed by the data packing section, when reading data from the single port memory, the memory control section reading together, from the single port memory, the data corresponding to predetermined number of pixels, after writing the data corresponding to predetermined number of pixels into the single port memory and before next data corresponding to predetermined number of pixels that are to be written into the single port memory are inputted to the line buffer circuit, the memory control section reading data from the single port memory, and in a case where data corresponding to a pixel at an end of a line is inputted to the line buffer circuit, even when the number of pixels whose data has been inputted to the line buffer circuit, but has not yet been written into the single port memory does not reach the predetermined number of pixels, the memory control section causing the data packing section to pack the unwritten data of the pixels and causing the packed data to be written together into the single port memory.

With the arrangement, when writing data into the single port memory, the memory control section writes together, into the single port memory, the plurality of data corresponding to predetermined number of pixels that are packed by the data packing section, and when reading data from the single port memory, the memory control section reads together, from the single port memory, the data corresponding to predetermined number of pixels. After writing the data corresponding to predetermined number of pixels into the single port memory and before next data corresponding to predetermined number of pixels that are to be written into the single port memory are inputted to the line buffer circuit, the memory control section reads data from the single port memory.

Consequently, the present invention allows performing the writing process and the reading process with a process time similar to the time required by a line buffer circuit including a dual port memory that is described in Patent Literature 1 for example. Further, unlike the technique of Patent Literature 1, the present invention does not include a dual port memory, and therefore the present invention may have a smaller circuit configuration than the technique of Patent Literature 1. That is, the present invention may have a smaller circuit configuration than a line buffer circuit including a dual port memory, and the present invention allows reading and writing of data with a process speed similar to that of the line buffer circuit including a dual port memory. Further, the present invention allows reducing the number of access to a memory, compared with a conventional line buffer circuit including a single port memory or a dual port memory. This allows reducing power consumption.

Further, with the arrangement, in a case where data corresponding to a pixel at an end of a line is inputted to the line buffer circuit, even when the number of pixels whose data has been inputted to the line buffer circuit, but has not yet been written into the single port memory does not reach the predetermined number of pixels, the memory control section causes the data packing section to pack the unwritten data of the pixels and causing the packed data to be written together into the single port memory.

Consequently, when the data corresponding to a pixel at the end of the line is inputted, it is possible to appropriately write the unwritten data of the pixels including the pixel at the end of the line into the single port memory.

Further, the line buffer circuit of the present invention may be arranged so as to further include: an input switch for switching a destination of data corresponding to a pixel that is inputted to the line buffer circuit; and an input-side data holding section for holding the data corresponding to a pixel that is inputted from the input switch, until the data is written into the single port memory, the input switch causing the input data corresponding to a pixel to be outputted to the input-side data holding section until data corresponding to a pixel in predetermined number is inputted, and when the data corresponding to the pixel in the predetermined number is inputted, the input switch causing the data corresponding to the pixel in the predetermined number to be outputted to the data packing section, and the data packing section packing data output from the input-side data holding section and data output from the input switch and regarding the packed data as the data corresponding to predetermined number of pixels.

With the arrangement, the input-side data holding section holds data corresponding to pixels before predetermined number. Consequently, when data corresponding to the pixel in predetermined number is inputted, data corresponding to pixels before and in predetermined number can be appropriately packed by the data packing section.

Further, the line buffer circuit of the present invention may be arranged so as to further include: an output-side data holding section for holding a part of a plurality of data corresponding to a pixel that have been unpacked by the data unpacking section; and an output switch for switching between data to be outputted to an outside of the line buffer circuit, the data unpacking section outputting, into the output switch, data corresponding to a first pixel of the unpacked data corresponding to a pixel, and outputting data corresponding to remaining pixels to the output-side data holding section, and the data output section outputting the data corresponding to the first pixel inputted from the data unpacking section and thereafter sequentially outputting the data corresponding to the remaining pixels that are inputted from the output-side data holding section, so that data is outputted with respect to each pixel.

With the arrangement, the data corresponding to the first pixel of data corresponding to respective pixels that are obtained by unpacking data corresponding to predetermined number of pixels that are read from the single port memory is outputted to the output switch, and data corresponding to remaining pixels are held by the output-side data holding section. This allows sequentially outputting data corresponding to respective pixels so that data is outputted with respect to each pixel.

The image processing apparatus of the present invention is an image processing apparatus, including: any of the above line buffer circuits; and an image processing section for performing a predetermined image process by use of data corresponding to a pixel that is outputted from the line buffer circuit.

With the arrangement, the line buffer circuit included in the image processing apparatus may have a smaller circuit configuration than that of a line buffer circuit including a dual port memory, and may perform reading and writing of data with a process speed similar to that of the line buffer circuit including a dual port memory.

The image processing apparatus of the present invention is an image forming apparatus, including: the above image processing apparatus; and an image forming section for forming on a recording material an image corresponding to image data outputted from the image processing apparatus.

With the arrangement, the line buffer circuit included in the image processing apparatus included in the image forming apparatus may have a smaller circuit configuration than that of a line buffer circuit including a dual port memory, and may perform reading and writing of data with a process speed similar to that of the line buffer circuit including a dual port memory.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

1. A line buffer circuit, including: a single port memory in which image data corresponding to 1 line is stored; and a memory control section for controlling writing and reading of data to and from the single port memory,
the line buffer circuit comprising:
a data packing section for packing a plurality of data corresponding to predetermined number of pixels, respectively, the data being to be written into the single port memory;
a data unpacking section for unpacking data corresponding to predetermined number of pixels, respectively, that is read out from the single port memory, into a plurality of data each corresponding to a pixel; and
a data output section for sequentially outputting the plurality of data each corresponding to a pixel in such a manner that each data is outputted with respect to each pixel, the plurality of data being obtained as a result of unpacking by the data unpacking section,
when writing data into the single port memory, the memory control section writing together, into the single port memory, the plurality of data corresponding to predetermined number of pixels that are packed by the data packing section,
when reading data from the single port memory, the memory control section reading together, from the single port memory, the data corresponding to predetermined number of pixels,
after writing the data corresponding to predetermined number of pixels into the single port memory and before next data corresponding to predetermined number of pixels that are to be written into the single port memory are inputted to the line buffer circuit, the memory control section reading data from the single port memory, and
in a case where data corresponding to a pixel at an end of a line is inputted to the line buffer circuit, even when the number of pixels whose data has been inputted to the line buffer circuit, but has not yet been written into the single port memory does not reach the predetermined number of pixels, the memory control section causing the data packing section to pack the unwritten data of the pixels and causing the packed data to be written together into the single port memory.

2. The line buffer circuit as set forth in claim 1, further comprising:
an input switch for switching a destination of data corresponding to a pixel that is inputted to the line buffer circuit; and
an input-side data holding section for holding the data corresponding to a pixel that is inputted from the input switch, until the data is written into the single port memory,
the input switch causing the input data corresponding to a pixel to be outputted to the input-side data holding section until data corresponding to a pixel in predetermined number is inputted, and when the data corresponding to the pixel in the predetermined number is inputted, the input switch causing the data corresponding to the pixel in the predetermined number to be outputted to the data packing section, and
the data packing section packing data output from the input-side data holding section and data output from the input switch and regarding the packed data as the data corresponding to predetermined number of pixels.

3. The line buffer circuit as set forth in claim 1, further comprising:
an output-side data holding section for holding a part of a plurality of data corresponding to a pixel that have been unpacked by the data unpacking section; and
an output switch for switching between data to be outputted to an outside of the line buffer circuit,
the data unpacking section outputting, into the output switch, data corresponding to a first pixel of the unpacked data corresponding to a pixel, and outputting data corresponding to remaining pixels to the output-side data holding section, and
the data output section outputting the data corresponding to the first pixel inputted from the data unpacking section and thereafter sequentially outputting the data corresponding to the remaining pixels that are inputted from the output-side data holding section, so that data is outputted with respect to each pixel.

4. An image processing apparatus, comprising: a line buffer circuit as set forth in claim 1; and an image processing section for performing a predetermined image process by use of data corresponding to a pixel that is outputted from the line buffer circuit.

5. An image forming apparatus, comprising: an image processing apparatus as set forth in claim 4; and an image forming section for forming on a recording material an image corresponding to image data outputted from the image processing apparatus.
